(19) United States
(12) Patent Application Publication
(10) Pub. No.: US 2007/0291046 A1
(43) Pub. Date: Dec. 20, 2007

(54) Color calibration method and device used for displaying device

(75) Inventors: Shu-Wen Chuang, Taipei (TW); Sheng-Fu Lan, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/453,802

(22) Filed: Jun. 16, 2006

(51) Int. Cl. G09G 5/02

(52) U.S. Cl. 345/589

(57) ABSTRACT

A color calibration method and device used for a displaying device, which is used to first calculate the RGB signal level value of the RGB colors of the first color signal, and next obtain the color area corresponding to the RGB signal level value through calculation and search, and then obtain the corresponding gamma value by utilizing the color area, and subsequently, calibrate the first color signal by making use of the gamma value to generate a second color signal, thus realizing the process of calibrating the first color signal. Through the application of the method and device, the automatic calibration of the displaying device color signal can be achieved at low costs, hereby realizing the optimal image quality.

### BACKGROUND

1. Field of Invention

The invention relates to a color calibration method and device, in particular to a color calibration method and device for a displaying device using Gamma values.

2. Related Art

Nowadays, with the rapid progress and development of the technology of the displaying device, the displaying device is widely used in 3C products for its characteristics of being light weight, having a thin profile, compact size, portability, and low power consumption. The utilization and application of the displaying device has gradually changed the life and working style of people's daily life, and it has become the important interface for man-machine communications. Therefore, the progress and development of the displaying device technology will evidently play an important role in the development of the future digital 3C displaying devices.

However, presently, upon finishing manufacturing, the light coloration of the red, green, and blue colors of the displaying device are calibrated to achieve the correct output colors. As such, upon acquiring a new displaying device by the user and displaying the images, it will produce various light colorations under various different environments, such as too dim or too bright light illumination. Thus the user has to manually adjust the red, green, and blue colors of the displaying device to produce the satisfying coloration. Therefore, when the light illumination of the ambient environment is constantly changing, then the user has to manually adjust the color intensity of the displaying device to produce the satisfying coloration. This is quite inconvenient for the user.

In addition, an alternative conventional color image calibration method is used to input the color bar patterns in the displaying device to be calibrated through a peripheral device. For instance, in calibrating the coloration of the computer monitor screens, a hard disk or peripheral data storage device such as a CD player or floppy disk player are utilized to output color bar patterns onto the computer monitor screen. Alternatively, in case the colors of the TV screen are to be calibrated, the color calibration is achieved by outputting the color bar pattern transmitted from the video recorder player or TV station onto the TV screen. Meanwhile, the color bar pattern is calibrated by a single color filter, so that the displaying device may produce images of satisfying coloration in various ambient environments.

Since the colors displayed on the displaying device are a combination of red, green, and blue colors, as such various other colors may be produced through the calibration of the three basic colors. Thus, to achieve the optimal image effect on the screen of the displaying device, the coloration of the displaying device must be calibrated according to the actual environment. However, the manual calibration of the image is rather complicated. Therefore, the question how to achieve the optimal overall image coloration and quality without having to go to the manual calibration process is one of the most important task in this field.

### SUMMARY OF THE INVENTION

In view of the above-mentioned drawbacks and shortcomings of the prior art, the objective of the invention is to provide a method and device used for calibrating the colors of a displaying device.

Therefore, to achieve the above-mentioned objectives, the invention discloses a color calibration method used for a displaying device, thus the displaying device is provided with at least an input terminal used to receive the first color signal, including the following steps: Firstly, storing the Gamma value selection table and the predetermined percentages, decoding the first color signal and outputting the RGB signal level values corresponding to the R, G, B colors. Next, calculating the RGB percentages in the RGB signal level value, and verifying that the RGB percentage is not smaller than the predetermined percentage. Then, obtaining the color area corresponding to the RGB percentage. Subsequently, obtaining the Gamma value of the corresponding color area from the gamma value selection table. And finally, calibrating the first color signal to generate the second color signal by making use of the gamma values thus obtained.

To achieve the above-mentioned objective, the invention discloses a device used for calibrating the colors of a displaying device, that is provided with at least an input terminal used to receive the first color signal, including: a color decoding unit, a color manipulation unit, a color comparison unit, a color area determination unit, a gamma value selection unit, and a coloration calibration unit. In the above-mentioned structure, the color decoding unit is used to decode the first color signal and output RGB signal level values of the corresponding RGB colors. The color manipulation unit is used to calculate and obtain the RGB percentage of the RGB signal level value. Moreover, the color comparison unit is provided with various predetermined percentages, which are used to obtain the color area corresponding to the RGB percentage through a color area acquisition unit, upon comparing and verifying that the RGB percentage is not less than the predetermined percentage. The gamma value selection unit is provided with a gamma value selection table, which is used to obtain the gamma value of the corresponding color area. Finally, the first color signal received at the input terminal is calibrated with the gamma value by the color calibration unit, thus producing the second color signal.

Therefore, in the application of the display color calibration method and device disclosed by the invention, the revised gamma value is used to calibrate the first color signal, thus changing and enhancing the illuminance of the colors. An essential merit and characteristic is the optimal overall image quality of the displaying device, which can be obtained without having to go through the process of manual image calibration.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow illustration only, and thus is not limitative of the present invention, wherein:

FIG. 1 is a system flowchart for the steps of a color calibration method used for a displaying device according to an embodiment of the invention; and

FIG. 2 is a system block diagram of a color calibration device used for a displaying device according to an embodiment of the invention.

### DETAILED DESCRIPTION OF THE INVENTION

The purpose, construction, features, and functions of the invention can be appreciated and understood more thoroughly through the following detailed description with reference to the attached drawings.

To obtain the optimal overall image quality of a displaying device, the color calibration of the displaying device is essential. In addition, the quality of the coloration of the displaying device will inevitably affect the results produced by the related input/output devices, such as the qualities of the colors of the scanner and printer, which are evidently affected by the quality of colors of the displaying device connected thereto. Thus, the colors of the displaying devices must be calibrated depending on the varying conditions of the environments, to ensure that the displaying device and the input/output devices connected thereto are operated according to the specification of the manufacturers.

In the implementation of the color calibration method of the invention, a series of color signals are transmitted and displayed on the screen of the displaying device, thus the displaying device is driven to the desired color and intensity through modifying its gamma values.

In general, the so-called Gamma value mentioned in the above description refers to a relation between the input and output. Namely, in a displaying system, the gamma value represents the relation between the RGB value in the file (input) and the light output of the displaying device (output). Usually, if the displaying device is to display high quality color images (regardless whether it is a high intensity image or low intensity image), then the contrast ratio is rarely over 5000:1. However, presently, the contrast ratio of the displaying device can only be made to be 500.1000:1 due to cost considerations, thus the gamma values are utilized to make calibration. Namely, for a dimm film, a higher Gamma value is selected (for example: 2, 3 or even 4), thus obtaining more dim portion levels. Conversely, for a bright film, a lower Gamma value (for example: 0, −1 or even −2) is selected, so that the bright portion level can be more distinct. In other words, the lower the Gamma value, the lighter the color, the higher the Gamma value, the darker the color.

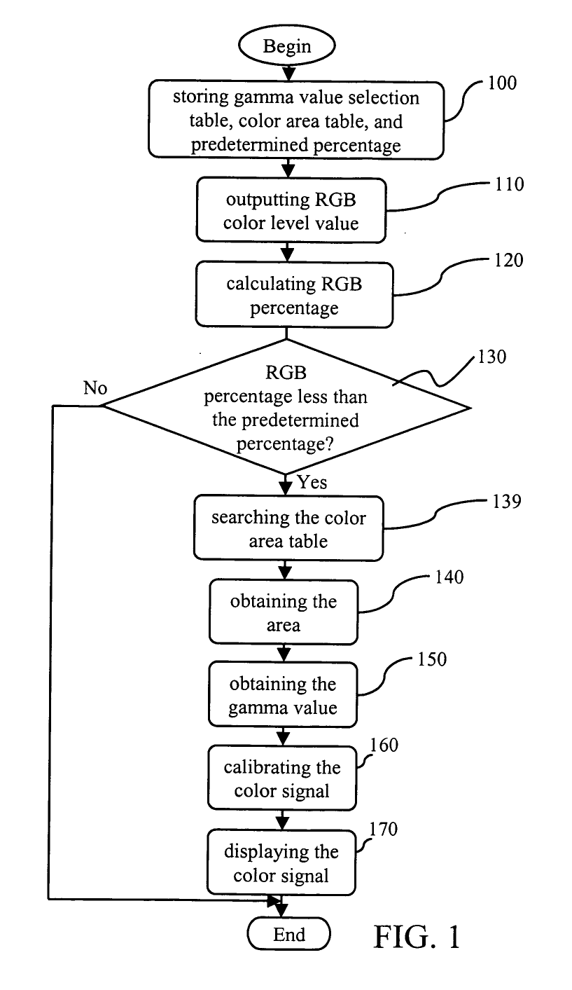

Firstly, refer to FIG. 1 for a system flowchart of the steps of a color calibration method used for a displaying device according to an embodiment of the invention. Such a displaying device is provided with at least an input terminal, used to receive the first color signal from a TV station or Cable TV Service Provider or various video data storage devices, such as: a video-recorder-player, memory device or CD player, including the following steps: Firstly, storing a gamma value selection table 51, a color area table 41, and the predetermined percentages (step 100). The gamma table 51 is used to store a plurality of gamma values, each corresponding to a different color area. The color area table 41 is used to store a plurality of color areas, each corresponding to a different RGB percentage. Besides, the predetermined percentage may be pre-stored or input manually through an input interface, such as a touch-control panel, an alphanumeric keyboard or other interface having input capability. Next, executing the decoding of the first color signal, and outputting the RGB signal level values corresponding to RGB colors (step 110). Namely, decoding the first color signal received at the input terminal of the displaying device, thus generating the YUB signal and converting the YUB signal into the corresponding RGB signal level value.

Then, calculating the RGB percentage of the RGB signal level value (step 120), namely, the ratio of the RGB signal level value, and verifying if the RGB percentage is no less than the predetermined percentage (step 130). In this process, the predetermined percentage is used as a standard to determine whether the color calibration is to be performed, which can be from 1 to 100. When the RGB percentage is less than the predetermined percentage, executing the termination step.

Subsequently, searching the color area table 41 by utilizing the RGB percentage (step 139), thus obtaining the color area corresponding to the RGB percentage (step 140). Namely, it is used to determine a particular RGB signal level value corresponding to the color area in the color area table 41, wherein the color area table 41 is provided with a plurality of color areas.

Furthermore, upon obtaining the gamma value corresponding to the color area from the gamma value selection table 51 (step 150), calibrating the first color signal utilizing the gamma value thus obtained and generating the second color signal (step 160). And finally, displaying the second color signal on the LCD panel, CRT screen or TV screen (step 170).

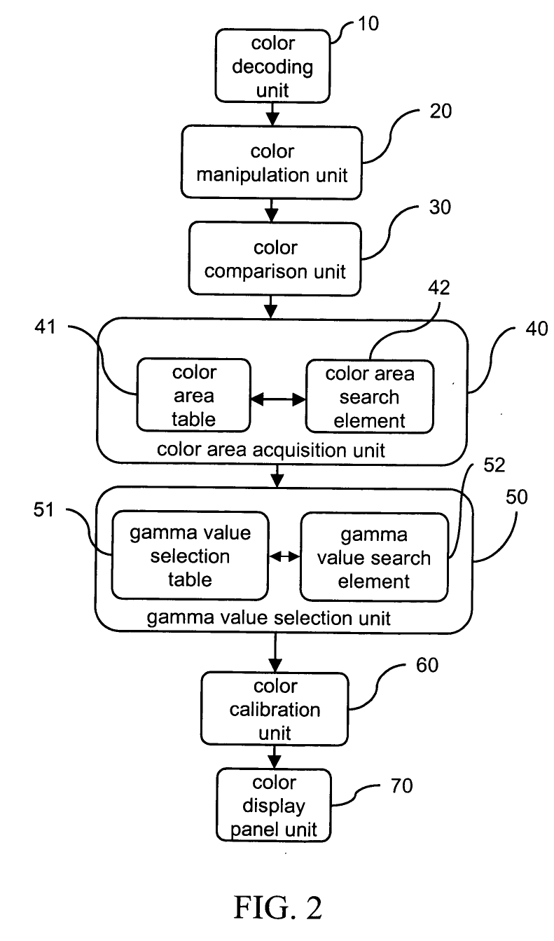

Refer to FIG. 2 for a system block diagram of a color calibration device used for a displaying device according to an embodiment of the invention. The displaying device is provided with at least an input terminal, used to receive the first color signal from a TV station or Cable TV Service Provider or various other video data storage devices, such as: a video-recorder-player, memory device or CD player. The color calibration device of the invention includes: a color decoding unit 10, a color manipulating unit 20, a color comparison unit 30, a color area acquisition unit 40, a gamma value selection unit 50, a color calibration unit 60, and a color display panel unit 70. The detailed description of the above-mentioned devices will be given as follows.

The color decoding unit 10, connected to the input terminal of the displaying device, and is used to decode the first color signal. The color decoder unit generates a YUB signal, and converts the YUB signal into the RGB signal level value corresponding to the RGB colors.

The color manipulation unit 20 is used to calculate the RGB percentage of the RGB signal level value, namely, the ratio of the RGB signal.

The color comparison unit 30, including the predetermined percentage stored in advance, is used to determine and verify that the RGB percentage is not less than the predetermined percentage, which is the basis used to determine whether to proceed with the color calibration. Such a predetermined percentage may be stored in advance or input manually through an interface, such as a touch control panel, an alphanumeric keyboard or other interface having input capabilities.

The color area acquisition unit 40 includes a color area table 41 and a color area search element 42. The color area look-up element 42 is used first to search the color area table 41 with the RGB percentage to obtain the corresponding color area, namely to determine the RGB signal level value, corresponding to a color area in the color area table 41, wherein the color area table 41 is provided with a plurality of color areas.

The gamma value selection unit 50 is used to search the gamma value selection table 51 established in advance through the gamma value search element 52 as based on the color area, to obtain the gamma value. Here, the gamma value selection table 51 is provided with a plurality of gamma values, each of them corresponding to a different color area.

The color calibration unit 60 is used to calibrate the first color signal received at the input terminal of the displaying device with the gamma value, hereby generating the second color signal. And finally, the color display panel unit 70, is connected to the color calibration unit 60 and is used to display the second color signal, wherein the color display panel unit 70 may be a LCD panel, a CRT screen or a TV screen.

In consideration of the economic benefit in manufacturing the displaying device, if the contrast ratio of its luminance is raised high enough to meet the actual requirements, then the costs would be increased several times. Instead, through the application of the displaying device color calibration method and device by making use of the gamma value as disclosed in the invention, the optimal overall image quality can be realized at low cost without having to adjust the image manually.

Knowing the invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A color calibration method used for a displaying device, said displaying device is provided with at least an input terminal to receive a first color signal, comprising the following steps:
storing a gamma value selection table and a predetermined percentage;
decoding said first color signal, and outputting a RGB signal level value corresponding to one of the RGB colors;
calculating the RGB percentage of said RGB signal level value;
when said RGB percentage is not less than said predetermined percentage, obtaining a color area corresponding to said RGB percentage;
obtaining a gamma value corresponding to said color area of said gamma value selection table; and
calibrating said first color signal utilizing said gamma value to generate a second color signal.

2. The color calibration method used for a displaying device as claimed in claim 1, further comprising the steps of:
storing a color area table, which is provided with a plurality of color areas, with each of them corresponding to a different RGB percentage; and
displaying said second color signal on the screen of the displaying device.

3. The color calibration method used for a displaying device as claimed in claim 2, wherein the step of obtaining the color area corresponding to said RGB percentage includes the step of searching the color area table to obtain said corresponding color area by making use of said RGB percentage.

4. The color calibration method used for a displaying device as claimed in claim 1, wherein in the step of verifying said RGB percentage is not less than said predetermined percentage, and when said RGB percentage is not less than said predetermined percentage, execute the termination step.

5. The color calibration method used for a displaying device as claimed in claim 1, wherein said gamma value selection table is stored with a plurality of gamma values, each corresponding to a different color area.

6. A color calibration device used for a displaying device, said displaying device is provided with at least an input terminal to receive a first color signal, comprising:
a color decoding unit, used to decode said first color signal and output a RGB signal level value corresponding to one of the RGB colors;
a color manipulation unit, used to calculate a RGB percentage of said RGB signal level value;
a color comparison unit, is provided with a predetermined percentage, and is used to compare and verify the said RGB percentage is not less said predetermined percentage;
a color area acquisition unit, used to obtain a color area corresponding to said RGB percentage;
a gamma value selection unit, is provided with a gamma value selection table, which is used to obtain a gamma value corresponding to said color area; and
a color calibration unit, used to calibrate said first color signal by making use of said gamma value and generate a second color signal.

7. The color calibration device used for a displaying device as claimed in claim 6, further comprising:
a color display panel unit, connected to said color calibration unit, and is used to display said second color signal.

8. The color calibration device used for a displaying device as claimed in claim 6, wherein said gamma value selection table is stored with a plurality of gamma values, each corresponding to a different color area.

9. The color calibration device used for a displaying device as claimed in claim 6, wherein said gamma value selection unit includes a gamma value search element, which is used to search said gamma value selection table by utilizing said color area, and obtain said corresponding gamma value.

10. The color calibration device used for a displaying device as claimed in claim 6, wherein said color area acquisition unit includes a color area table.

11. The color calibration device used for a displaying device as claimed in claim 10, wherein said color area acquisition unit further includes a color area search element, which is used to search said color area table by utilizing said RGB percentage, and obtain said corresponding color area.
